(19) United States
(12) Patent Application Publication
(10) Pub. No.: US 2019/0157793 A1
(43) Pub. Date: May 23, 2019

(54) CONNECTOR

(71) Applicant: Molex, LLC, Lisle, IL (US)

(72) Inventors: You Xiang Zheng, Pudong (CN); Pierre Perez, Aurora, IL (US)

(73) Assignee: Molex, LLC, Lisle, IL (US)

(21) Appl. No.: 16/113,398

(22) Filed: Aug. 27, 2018

(30) Foreign Application Priority Data
Aug. 30, 2017 (CN) 201721102867.3

(51) Int. Cl. H01R 13/422

(52) U.S. Cl. CPC H01R 13/4223; H01R 2107/00

(57) ABSTRACT

The present disclosure is a connector which comprises an insulating housing and a plurality of terminals. The insulating housing comprises a plurality of terminal receiving channels, each terminal receiving channel extends along a front-rear direction and has a wall portion and a locking bar provided on the wall portion, two end of the locking bar are connected with the wall portion in the front-rear direction, the locking bar is separated from the wall portion in a left-right direction perpendicular to the front-rear direction. The locking bar comprises: a locking block protruding into the terminal receiving channel; and an unlocking block exposed outside the insulating housing and protruding outwardly. Each terminal is assembled in the terminal receiving channel of the insulating housing, each terminal defines a locking portion, the locking portion latches with the locking block of the locking bar of the terminal receiving channel. The design of the unlocking block of the present disclosure allows the terminal to be easier pulled out from the terminal receiving channel and does not cause damage to the terminal or the terminal receiving channel.

### RELATED APPLICATIONS

This application claims priority to Chinese Application No. 201721102867.3, filed Aug. 30, 2017, which is incorporated herein by reference in its entirety.

### TECHNICAL FIELD

The present disclosure relates to a connector, especially to a connector which comprises an insulating housing and terminals

### BACKGROUND ART

The connector is widely applied in electronic products, such as a force connector, which comprises a terminal used for connecting a wire and an insulating housing receiving the terminal.

Chinese Patent Application CN94107247.9 (Chinese Patent Publication CN1100237A, corresponds to U.S. Pat. No. 5,520,548) discloses a simple-supported beam-type terminal locking configuration, which is provided in a terminal receiving channel of an insulating housing and has a recess, the recess is used to latch with a corresponding detent of the terminal to achieve engagement of the insulating housing and the terminal. This design can provide a stronger locking force for the terminal compared to the single cantilever type locking configuration of a traditional insulating housing.

In other general traditional connectors, after the terminal is assembled into the terminal receiving channel, the terminal gets stuck by using a locking protrusion in the terminal receiving channel. The general locking protrusion is a single cantilever type configuration. Accordingly, when the terminal needs to be pulled out from the terminal receiving channel, a special tool is usually used to insert into the terminal receiving channel to push aside the single cantilever type locking protrusion. However, because the special tool needs to insert between the terminal and the terminal receiving channel, the special tool would often damage the terminal or break off the single cantilever type locking protrusion.

Furthermore, because the locking configuration in the above Chinese patent application has a locking force stronger than that of other traditional connectors, when it is necessary to reprocess or reassemble the terminal disclosed in the above Chinese patent application, the locking configuration in the above Chinese patent application makes the terminal more difficult to be pulled out.

### SUMMARY

An object of the present disclosure is to provide a connector to overcome the defect and deficiency in the prior art.

To achieve the above object, the present disclosure provides a connector, which comprises an insulating housing and a plurality of terminals. The insulating housing comprises a plurality of terminal receiving channels, each terminal receiving channel extends along a front-rear direction and has a wall portion and a locking bar provided on the wall portion, two end of the locking bar are connected with the wall portion in the front-rear direction, the locking bar is separated from the wall portion in a left-right direction perpendicular to the front-rear direction. The locking bar comprises: a locking block protruding into the terminal receiving channel; and an unlocking block exposed outside the insulating housing and protruding outwardly. Each terminal is assembled in the terminal receiving channel of the insulating housing, each terminal defines a locking portion, the locking portion latches with the locking block of the locking bar of the terminal receiving channel.

In some embodiments, a tip end of the unlocking block is formed as a hook.

In some embodiments, the locking block and the unlocking block of the locking bar are positioned respectively at a position of an inside of the locking bar and a position of an outside of the locking bar.

In some embodiments, the locking block and the unlocking block are positioned at a center position of the locking bar.

In some embodiments, each terminal receiving channel of the insulating housing further comprises a stopping wall, each terminal further comprises a stopping portion, the stopping portion abuts against the stopping wall.

In some embodiments, the stopping wall and the locking bar are positioned to face each other in an up-down direction.

In some embodiments, the locking block has a stopping surface perpendicular to the front-rear direction, the locking portion is formed as a notch having a front edge, the front edge is used to abut against the stopping surface to limit the terminal to move backwardly when the terminal is pulled out from the terminal receiving channel.

The beneficial effects of the present disclosure are: in the embodiment of the present disclosure, each terminal receiving channel of the insulating housing of the connector has a design of the locking bar comprising the locking block and the unlocking block, so when the terminal assembled in the terminal receiving channel is pulled out, the locking bar is elastically displaced by pulling the unlocking block, so that the locking block moves out from the locking portion of the terminal, which allows the terminal to be easily pulled out from the terminal receiving channel. The present disclosure is different from the traditional method, the present disclosure is not necessary to use a tool to insert between the terminal receiving channel and the terminal when the terminal is pulled out, so it can avoid damage to the terminal or the terminal receiving channel.

Technical features and advantages of the present disclosure are widely summarized as above, so as to better understand the following detailed description. Other technical feature making up technical solutions of the claims of the present disclosure and other advantages will be described below. A person skilled in the art of the present disclosure shall understand that the concept and specific embodiments disclosed below may be easily used to modify or design other configuration or manufacturing approach so as to realize the same object as the present disclosure. A person skilled in the art of the present disclosure shall also understand that, such an equivalent configuration or approach cannot be departed from the spirit and scope of the present disclosure defined by the appended claims.

### BRIEF DESCRIPTION OF THE DRAWINGS

The various respects of the present disclosure may be best understood by the following detailed description taken in connection with the accompanying figures. It should be noted that, according to a standard implementing mode of the industries, features are not drawn as the scale. In practice, for the sake of clear explanation, various features may be arbitrarily enlarged or reduced in dimension.

FIG. 1 is a top perspective schematic view of a connector of an embodiment of the present disclosure.

FIG. 2 is a bottom perspective schematic view of the connector of FIG. 1.

FIG. 3 is a partially enlarged perspective exploded schematic view taken along a line A-A of the connector of FIG. 1.

FIG. 4 is a partially enlarged perspective assembled schematic view taken along a line A-A of the connector of FIG. 1.

FIG. 5 is a bottom view of the connector of FIG. 1.

FIG. 6 is a cross sectional schematic view taken along a line Z-Z of the connector of FIG. 5.

### DETAILED DESCRIPTION OF THE PREFERRED EMBODIMENTS

The following disclosed content provides various embodiments or examples used to implement various features of the present disclosure. Elements and configurations in specific examples are described as follows, so as to simplify the disclosed content of the present disclosure. Certainly, these are merely examples, and are not used to limit the present disclosure. For example, in the following description, that a first feature is formed on or above a second feature may comprise an embodiment that the first feature and the second are formed to directly contact with each other, may also comprise an embodiment that other feature is formed between the first feature and the second feature, therefore the first feature and the second feature do not directly contact with each other. Moreover, the present disclosure may allow a symbol and/or a character of an element to be repeated in different examples. The repetition is used for simplification and clearness, but is not used to dominate a relationship between various embodiments and/or discussed structures.

Moreover, the present disclosure may use spatial corresponding terminologies, such as “below”, “lower than”, “relative lower”, “higher than”, “relative high” and the like, so as to describe a relationship between an elements or feature and another element or feature. Spatial corresponding terminologies are used to comprise various orientations of an apparatus in use or operation besides orientations illustrated in Figures. Or the apparatus may be orientated (rotated by 90 degrees or at other orientation), and the corresponding spatial description in the present disclosure may be correspondingly explained. It should be understood that, when a feature is formed to another feature or above a substrate, other features may be presented between them.

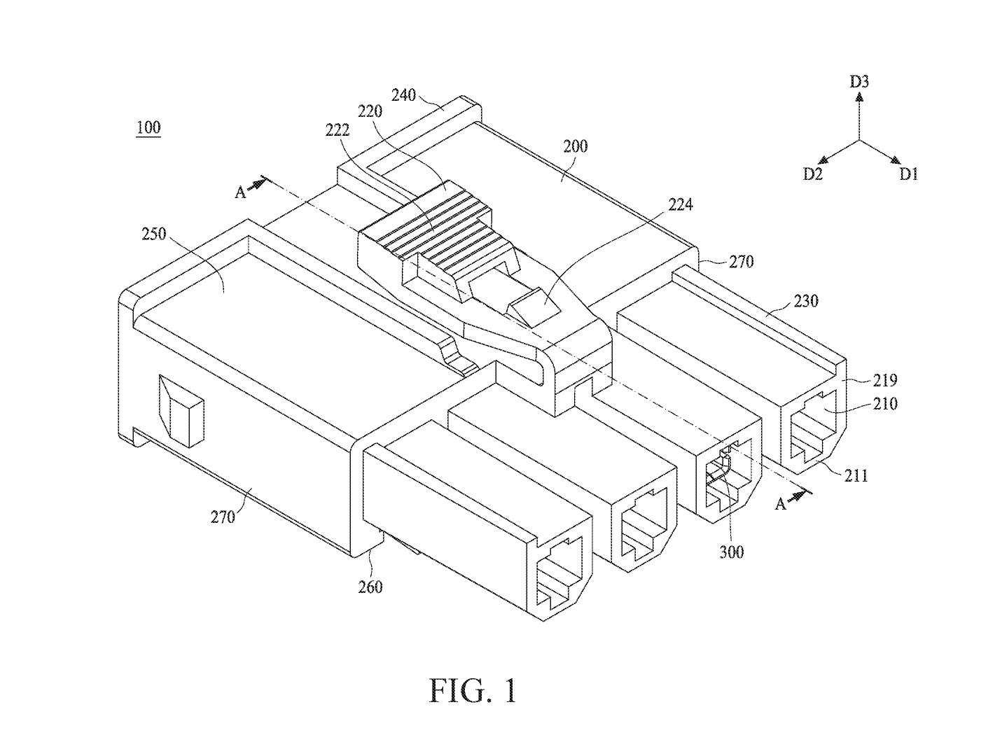

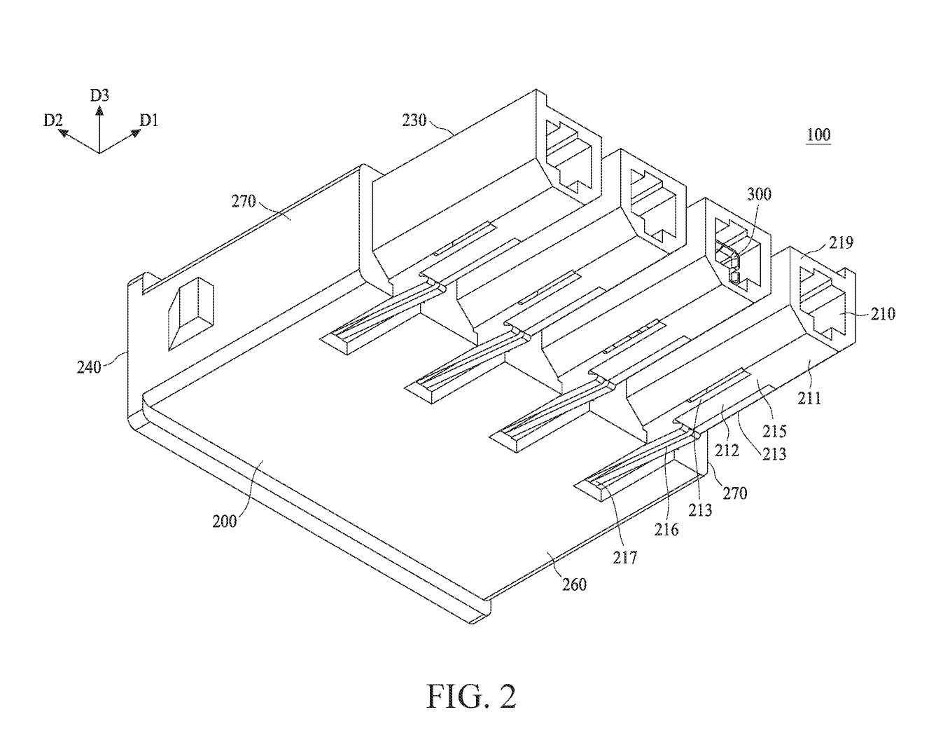

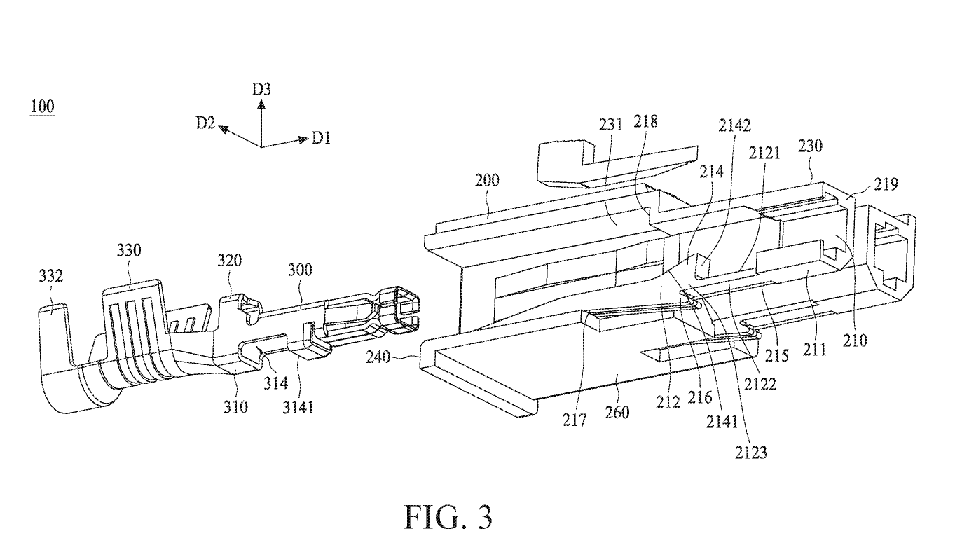

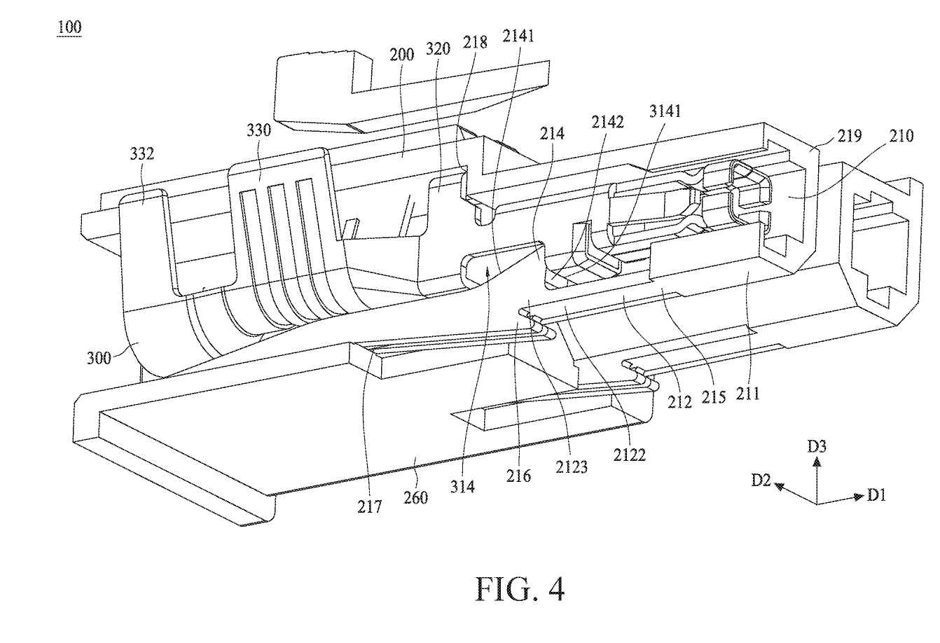

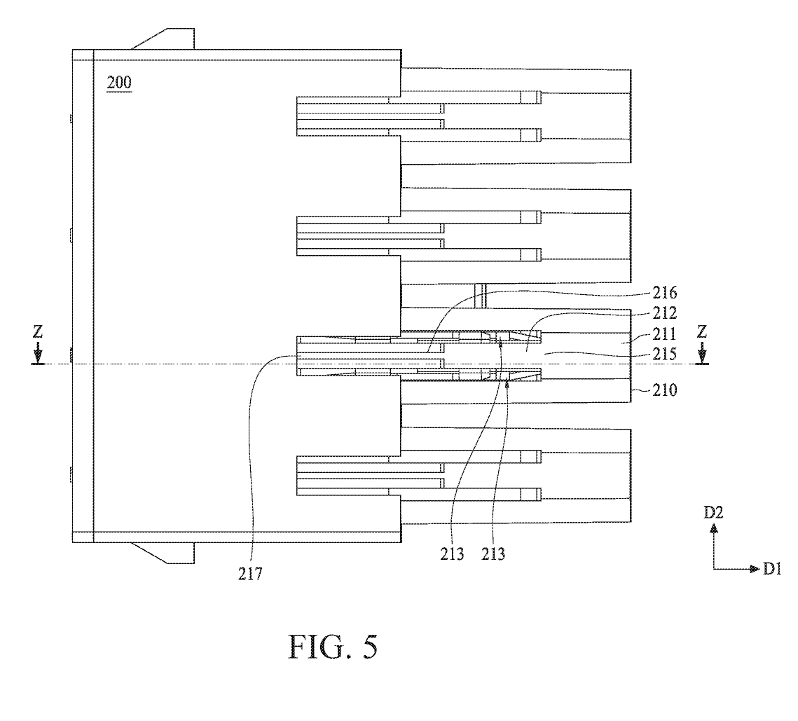

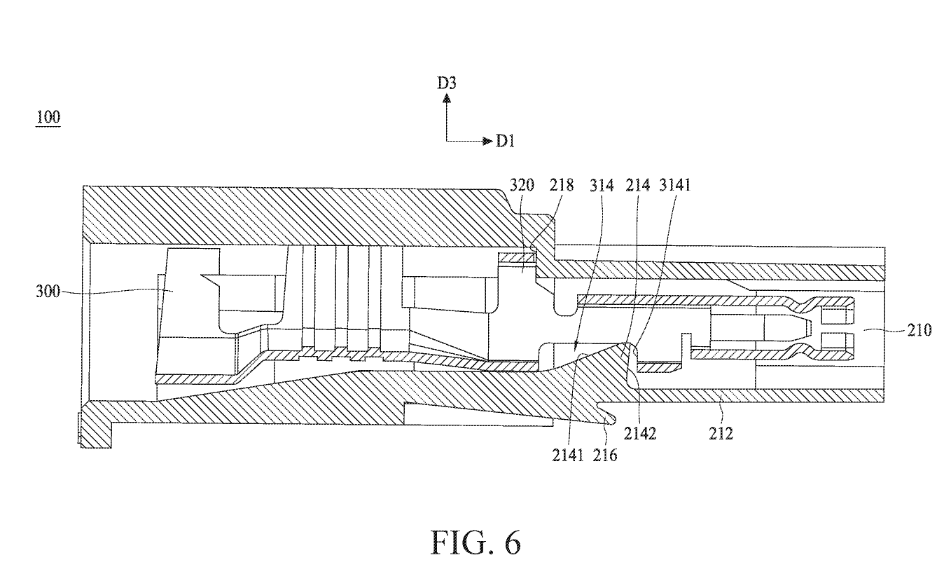

FIG. 1 is a top perspective schematic view of a connector 100 of an embodiment of the present disclosure. FIG. 2 is a bottom perspective schematic view of the connector 100 of FIG. 1, in which the connector 100 comprises an insulating housing 200 and a plurality of terminals 300. For brevity of illustration, only one terminal 300 is shown. FIG. 3 is a partially enlarged perspective exploded schematic view taken along a line A-A of the connector 100 of FIG. 1. FIG. 4 is a partially enlarged perspective assembled schematic view taken along a line A-A of the connector 100 of FIG. 1. FIG. 5 is a bottom view of the connector 100 of FIG. 1. FIG. 6 is a cross sectional schematic view taken along a line Z-Z of the connector 100 of FIG. 5. Referring to FIG. 1 to FIG. 6, the insulating housing 200 has a mating end 230 and a rear end 240 opposite to the mating end 230 in a front-rear direction D1, a top surface 250 and a bottom surface 260 in an up-down direction D3 and two side surfaces 270 in a left-right direction D2. In addition, the insulating housing 200 comprises a mating lock 220 and a plurality of terminal receiving channels 210.

The mating lock 220 is integrally provided on the top surface 250 of the insulating housing 200. The mating lock 220 comprises a protruding block 224 and a pressing portion 222, the mating lock 220 is used for locking or unlocking after mating with an insulating housing of another connector (not shown).

Each terminal receiving channel 210 extends from the rear end 240 to the mating end 230 of the insulating housing 200 along the front-rear direction D1, a plurality of mating columns 219 is formed on the mating end 230 of the insulating housing 200 in the illustrated embodiment, each terminal receiving channel 210 extends from the rear end 240 of the insulating housing 200 into the corresponding mating column 219. Each terminal receiving channel 210 comprises a wall portion 211 positioned below, a locking bar 212 and a stopping wall 218. The locking bar 212 is integrally formed on the wall portion 211, two ends 215, 217 of the locking bar 212 are positioned at the front-rear direction D1 and connect with the wall portion 211, and the locking bar 212 is separated from the wall portion 211 in the left-right direction D2, that is, in the left-right direction D2, two grooves 213 (as shown in FIG. 2 and FIG. 5) extending in the front-rear direction D1 are provided between the wall portion 211 and the locking bar 212, with such a configuration, the locking bar 212 is configured as a simple supported beam-type locking bar 212 with the front and rear ends 215, 217 as supported points. The simple supported beam-type design can increase the locking force of the locking bar 212, which allows the terminal 300 to be more firmly held in the terminal receiving channel 210. The locking bar 212 in the illustrated embodiment is formed on the wall portion 211 which is positioned below, but also can be provided on an upper wall portion or other wall portion (not indicated by a reference numeral). In the embodiment, the stopping wall 218 is positioned on an inner wall surface 231 facing the locking bar 212 in the terminal receiving channel 210 and faces to the rear direction, furthermore, in the embodiment, the stopping wall 218 and the locking bar 212 are positioned to face each other in the up-down direction D3, this design allows the terminal 300 to be fixed in the terminal receiving channel 210 in a more balanced manner. In other embodiments, the stopping wall 218 can also be provided on other inner wall surface (not indicated by a reference numeral) of the terminal receiving channel 210.

The locking bar 212 comprises a locking block 214 and an unlocking block 216. The locking block 214 is provided on an inner surface 2121 of the locking bar 212 which faces the inside of the terminal receiving channel 210, the locking block 214 protrudes into the terminal receiving channel 210 and is used to lock the terminal 300. The unlocking block 216 is provided on an outer surface 2122 of the locking bar 212 opposite to the terminal receiving channel 210, and the unlocking block 216 is exposed outside the insulating housing 200 and protrudes outwardly. Accordingly, when the terminal 300 needs to be pulled out from the terminal receiving channel 210, by pulling the unlocking block 216, the locking bar 212 is elastically displaced (elastically displaced downwardly) toward the outside of the terminal receiving channel 210, and in turn the terminal 300 locked by the locking block 214 is unlocked.

In some embodiments, a tip end of the unlocking block 216 may be formed as a hook or any other shape which is easy to pull, which allows the user to more easily pull the unlocking block 216 and in turn allows the locking bar 212 to be elastically displaced outwardly more easily. In some embodiments, the locking block 214 and the unlocking block 216 are configured to be positioned respectively at a position of an inside of the locking bar 212 and a position of an outside of the locking bar 212, and the locking block 214 and the unlocking block 216 may be preferably positioned at a center position 2123 of the locking bar 212, and the center position 2123 of the locking bar 212 with a simple supported beam-type has greater elasticity and displacement, so that the locking block 214 can be more directly and easily operated to displace upon pulling the unlocking block 216. The stopping wall 218 is configured to stop the terminal 300 when the terminal 300 is assembled with the terminal receiving channel 210, which assists in positioning the terminal 300.

Referring to FIG. 3, FIG. 4 and FIG. 6, each terminal 300 comprises a locking portion 314, a stopping portion 320, a first wire clamping portion 330 and a second wire clamping portion 332. When the terminal 300 is assembled with the terminal receiving channel 210, the terminal 300 is inserted into the terminal receiving channel 210 from the rear to the front in the front-rear direction D1, the stopping portion 320 of the terminal 300 will abut against the stopping wall 218 of the terminal receiving channel 210 and is stopped by the stopping wall 218 to be limited to move forwardly, and the locking portion 314 of the terminal 300 is latched by the locking block 214 of the locking bar 212 of the terminal receiving channel 210 and in turn is limited to move backwardly, so that the terminal 300 is assembled and fixed in the terminal receiving channel 210. The first wire clamping portion 330 is used for clamping a center conductor portion of an external wire (not shown), and the second wire clamping portion 332 is used for clamping an insulation sheath portion of the external wire (it should be noted that the illustrated terminal 300 of the present disclosure is in a state without clamping a wire). The locking portion 314 in the embodiment is a notch formed on a bottom surface 310 of the terminal 300, of course, the locking portion 314 can be equivalently changed to other configurations and shapes to lock with the locking block 214. Specifically, the locking block 214 has an inclined guiding surface 2141 gradually raised from the rear to the front and a stopping surface 2142 which is upright (perpendicular to the front-rear direction D1). When the terminal 300 is inserted, the inclined guide surface 2141 makes the terminal 300 to push the locking block 214 and in turn the locking block 214 brings the locking bar 212 to be elastically displaced outwardly, and after a front edge 3141 of the notch formed by the locking portion 314 passes over the locking block 214, the locking bar 212 elastically recovers to allow the locking block 214 to enter into and latch with the notch formed by the locking portion 314 and the front edge 3141 of the notch formed by the locking portion 314 is positioned in front of the stopping surface 2142 of the locking block 214. When the terminal 300 is pulled backwardly, the front edge 3141 will abut against the stopping surface 2142 to limit the terminal 300 to move backwardly.

As described above, when the terminal 300 is pulled out from the terminal receiving channel 210, the locking bar 212 is elastically displaced toward the outside of the terminal receiving channel 210 by pulling the unlocking block 216, and in turn the locking block 214 moves out from the locking portion 314 of the terminal 300, which allows the terminal 300 to be easily pulled out from the terminal receiving channel 210. The design of the present disclosure is different from the traditional method, the design of the present disclosure is not necessary to use a specially customized tool to insert between the terminal receiving channel 210 and the terminal 300, since the unlocking block 216 is exposed outside the terminal receiving channel 210, so that a general or simple tool can be used to pull the locking bar 212 to unlock the terminal 300, and the tool is not inserted into the terminal receiving channel 210 and does not contact the terminal 300, so it can avoid damage to the terminal 300 or the terminal receiving channel 210.

Features of some embodiments are summarized in above content, so that a person skilled in the art may better understand various aspects of the disclosed content of the present disclosure. A person skilled in the art of the present disclosure shall understand that the disclosed content of the present disclosure may be easily used to design or modify other manufacturing approach or configuration and in turn to realize the same object and/or attain the same advantage as the embodiments of the present disclosure. A person skilled in the art of the present disclosure shall also understand that, such an equivalent approach or configuration cannot be departed from the spirit and scope of the disclosed content of the present disclosure, and a person skilled in the art may make various changes, substitutions and replacements, which are not departed from the spirit and scope of the disclosed content of the present disclosure.

1. A connector, comprising:
an insulating housing comprising a plurality of terminal receiving channels, each terminal receiving channel extending along a front-rear direction and having a wall portion and a locking bar provided on the wall portion, two end of the locking bar being connected with the wall portion in the front-rear direction, the locking bar being separated from the wall portion in a left-right direction perpendicular to the front-rear direction, the locking bar comprising:
a locking block protruding into the terminal receiving channel; and
an unlocking block exposed outside the insulating housing and protruding outwardly; and
a plurality of terminals, each terminal being assembled in the terminal receiving channel of the insulating block of the locking bar of the terminal receiving channel.

2. The connector of claim 1, wherein a tip end of the unlocking block is formed as a hook.

3. The connector of claim 1, wherein the locking block and the unlocking block of the locking bar are positioned respectively at a position of an inside of the locking bar and a position of an outside of the locking bar.

4. The connector of claim 3, wherein the locking block and the unlocking block are positioned at a center position of the locking bar.

5. The connector of claim 1, wherein each terminal receiving channel of the insulating housing further comprises a stopping wall, each terminal further comprises a stopping portion, the stopping portion abuts against the stopping wall.

6. The connector of claim 5, wherein the stopping wall and the locking bar are positioned to face each other in an up-down direction.
